(19) United States
(12) Patent Application Publication
(10) Pub. No.: US 2020/0355873 A1
(43) Pub. Date: Nov. 12, 2020

(54) OPTICAL CONNECTOR AND OPTICAL CONNECTOR ASSEMBLY

(71) Applicant: 3M INNOVATIVE PROPERTIES COMPANY, St. Paul, MN (US)

(72) Inventors: Daniel F. Cronch, Denver, CO (US); Nicholas A. Lee, Woodbury, MN (US); Boon K. Lee, Leander, TX (US); Michael A. Haase, St. Paul, MN (US); Changbao Ma, Austin, TX (US)

(21) Appl. No.: 15/733,106

(22) PCT Filed: Jan. 10, 2019
(86) PCT No.: PCT/IB2019/050199

§ 371 Date: May 18, 2020

Related U.S. Application Data
(60) Provisional application No. 62/618,139, filed on Jan. 17, 2018.

(51) Int. Cl. G02B 6/38; G02B 6/40

(52) U.S. Cl. CPC G02B 6/3849; G02B 6/3879; G02B 6/3839; G02B 6/406

(57) ABSTRACT

An optical connector includes multiple optical subconnectors, wherein each optical subconnector comprises a subconnector housing and one or more optical cable assemblies. The optical connector has two or more housing components, including at least a first housing component and a second housing component. Control of x, y, and z translation of the multiple optical subconnectors is distributed between the first and second housing components such that each housing component controls movement of the optical subconnectors along at least one but not all of the x, y, and z axes.

### BACKGROUND

Optical connectors can be used for optical communications in a variety of applications including telecommunications networks, local area networks, data center links, and internal links in computer devices. Expanded optical beams may be used in connectors for these applications to provide an optical connection that is less sensitive to dust and other forms of contamination and so that alignment tolerances may be relaxed. Generally, an expanded beam is a beam that is larger in diameter than the core of an associated optical waveguide (usually an optical fiber, e.g., a multi-mode fiber for a multi-mode communication system). The connector is generally considered an expanded beam connector if there is an expanded beam at a connection point. The expanded beam is typically obtained by diverging a light beam from a source or optical fiber. In many cases, the diverging beam is processed by optical elements such as a lens or mirror into an expanded beam that is approximately collimated. The expanded beam is then received by focusing of the beam via another lens or mirror.

### BRIEF SUMMARY

Some embodiments are directed to an optical subconnector that includes a subconnector housing and one or more optical cable assemblies disposed within the subconnector housing. Each optical cable assembly comprises at least one optical ferrule and at least one optical waveguide. A shutter that covers mating ends of the optical ferrules. A shutter activation mechanism is coupled to the shutter and reversibly engages with a shutter activation mechanism of a mating optical subconnector. During unmating of the optical subconnector and the mating optical subconnector, the shutter activation mechanism of the mating optical subconnector pulls the shutter activation mechanism of the optical subconnector along a mating axis of the optical subconnector causing the shutter to close.

According to some embodiments, an optical connector includes a housing with one or more optical subconnectors as discussed above disposed within the housing.

Some embodiments are directed to an optical connector that includes a carrier with multiple optical subconnectors disposed within the carrier. Each optical subconnector includes a subconnector housing and one or more optical cable assemblies disposed within the subconnector housing. The optical connector includes a movement control component separable from the multiple optical subconnectors and the carrier that is configured to control movement of the multiple optical subconnectors along a mating axis of the optical connector.

Some embodiments involve an optical connector comprising multiple optical subconnectors, each optical subconnector comprising a subconnector housing and one or more optical cable assemblies. The optical connector also includes two or more housing components, including at least a first housing component and a second housing component. Control of x, y, and z translation of the multiple optical subconnectors is distributed between the first and second housing components such that each housing component controls movement of the optical subconnectors along at least one but not all of the x, y, and z axes.

Embodiments are directed to an optical connector comprising a carrier having multiple optical subconnectors disposed within the carrier. Each optical subconnector includes a subconnector housing and one or more optical cable assemblies, each optical cable assembly comprising at least one optical ferrule and at least one optical waveguide. The optical connector has a retaining clip configured to be inserted and removed from the carrier. The retaining clip prevents movement of one or more of the multiple optical subconnectors along a mating axis of the optical connector when the mating clip is disposed within the carrier.

According to some embodiments, an optical connector includes a base housing, a carrier disposed within the base housing, and multiple optical subconnectors disposed within the carrier. Each optical subconnector includes a subconnector housing and one or more optical cable assemblies. Each optical cable assembly comprises at least one optical ferrule and at least one optical waveguide. The optical connector has a float coupling that allows limited translational movement of the carrier and the optical subconnectors along the mating axis of the optical connector. According to some implementations, the float coupling between the base housing and the carrier allows simultaneous translational movement of the carrier and all of the multiple optical subconnectors along a mating axis of the optical connector.

According to some embodiments, an optical connector assembly comprises first and second optical connectors configured to be mated together. Each optical connector includes multiple optical subconnectors, each comprising a subconnector housing and one or more optical cable assemblies. Each optical connector includes a first housing component and a second housing component. Control of x, y, and z translation of the multiple optical subconnectors is distributed between the first and second housing components such that each housing component controls movement of all of the multiple optical subconnectors along at least one but not all of the x, y, and z axes.

### BRIEF DESCRIPTION OF DRAWINGS

FIG. 1 shows an optical cable assembly in accordance with some embodiments;

FIG. 2A is a cutaway view of a portion of an optical ferrule in accordance with some embodiments showing features of the light redirecting member and waveguide attachment area;

FIG. 2B is a cutaway view of a portion of an optical ferrule that includes just one light redirecting element, one waveguide alignment member, e.g., groove, and one optical fiber;

FIG. 3 illustrates a side view of two optical cable subassemblies showing mated optical ferrules attached to optical waveguides at ferrule attachment areas in accordance with some embodiments;

FIG. 4A shows an optical cable subconnector in accordance with some embodiments;

FIG. 4B shows two optical cable subconnectors as in FIG. 4A after mating;

FIGS. 4C through 4G are a sequence of diagrams that show the optical subconnector and mating optical subconnector during the process of mating in accordance with some embodiments;

FIGS. 4H through 4J are a sequence of diagrams that show the optical subconnector and mating optical subconnector during the process of unmating in accordance with some embodiments;

FIG. 5 provides a perspective view of optical connector in accordance with some embodiments;

FIG. 6 provides an exploded perspective view of the optical connector of FIG. 5;

FIG. 7 shows the first and second housing components of the optical connector of FIG. 5 in more detail;

FIGS. 8 and 9 are perspective views of an optical connector in accordance with some embodiments;

FIG. 10 is an exploded perspective view showing the first and second housing components of the optical connector of FIGS. 8 and 9 in more detail; and

FIG. 11 is perspective view of a connector assembly that includes the connector of FIG. 5 and the connector of FIG. 8.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

Embodiments described herein are directed to optical connectors and optical connector assemblies. Optical connectors and assemblies described herein make optical connections between one or more waveguides and one or more mating waveguides. The individual waveguides are typically made of glass with a protective buffer coating, and the parallel waveguides are enclosed by a jacket. Optical connectors as discussed herein are useful for connecting optical waveguides to optical waveguides in backplane or midplane applications.

Expanded beam optical connections provide a beam that is larger in diameter than the core of an associated optical waveguide and typically somewhat less than the waveguide-to-waveguide pitch. These expanded beam optical connectors can have non-contact optical coupling that can require reduced mechanical precision when compared with conventional physical contact optical connectors that do not use expanded beams. When an optical connector on a printed circuit (PC) board mates with an optical connector on a midplane or backplane, the mating mis-alignment at each connector increases as the number of connectors being mated increases. When both electrical and optical connectors are being simultaneously mated, the mechanical constraints of the mating electrical connectors dominate, increasing the misalignment that the optical connectors must tolerate. The alignment of the mating optical connectors, which can be relatively more sensitive to misalignment than the electrical connectors, are constrained by the electrical connectors. Some embodiments disclosed herein involve approaches in which optical connector components allow for limited translational movement of the connector housing and/or of the optical cable subassemblies within the connector housing during mating to provide for proper alignment of the optical connections.

FIG. 1 shows an optical cable assembly in accordance with some embodiments. The optical cable assembly includes one or more optical waveguides 110 and an optical ferrule 120. The term optical waveguide is used herein to refer to an optical element that propagates signal light. An optical waveguide comprises at least one core with a cladding, wherein the core and cladding are configured to propagate light within the core, e.g., by total internal reflection. An optical waveguide may be, for example, a single or multi-mode waveguide, a single core fiber, a multi-core optical fiber, or a polymeric waveguide. A waveguide may have any suitable cross sectional shape, e.g., circular, square, rectangular etc.

In some embodiments, the optical cable assembly includes a cable retainer 130. The optical waveguides are permanently attached to the optical ferrule 120 at a ferrule attachment area 108. In embodiments that include a cable retainer 130, the optical waveguides 110 are attached to the retainer 130 at the retainer attachment area 131. The cable retainer 130 can be used to secure the optical cable assembly within a connector housing.

The optical ferrule 120 is configured to mate, e.g., hermaphroditically, with another ferrule. The ferrule 120 illustrated in FIG. 1 includes a mechanical mating tongue 116. In some embodiments, the mechanical mating tongue 116 can have a tapering width along at least a portion of a length of the tongue portion as shown in the illustrations. The mechanical mating tongue 116 can extend outwardly from a front of a connector housing (not shown in FIG. 1).

The ferrule attachment area 108 may include a plurality of grooves 114 each groove being configured to accommodate a different optical waveguide of the optical waveguides 110. The grooves are configured to receive an optical waveguide and each optical waveguide 110 is permanently attached to a respective groove 114 at the ferrule attachment area 108, e.g., using an adhesive. Light redirecting members 112 redirect input light from the optical waveguides toward an output window (not shown in FIG. 1).

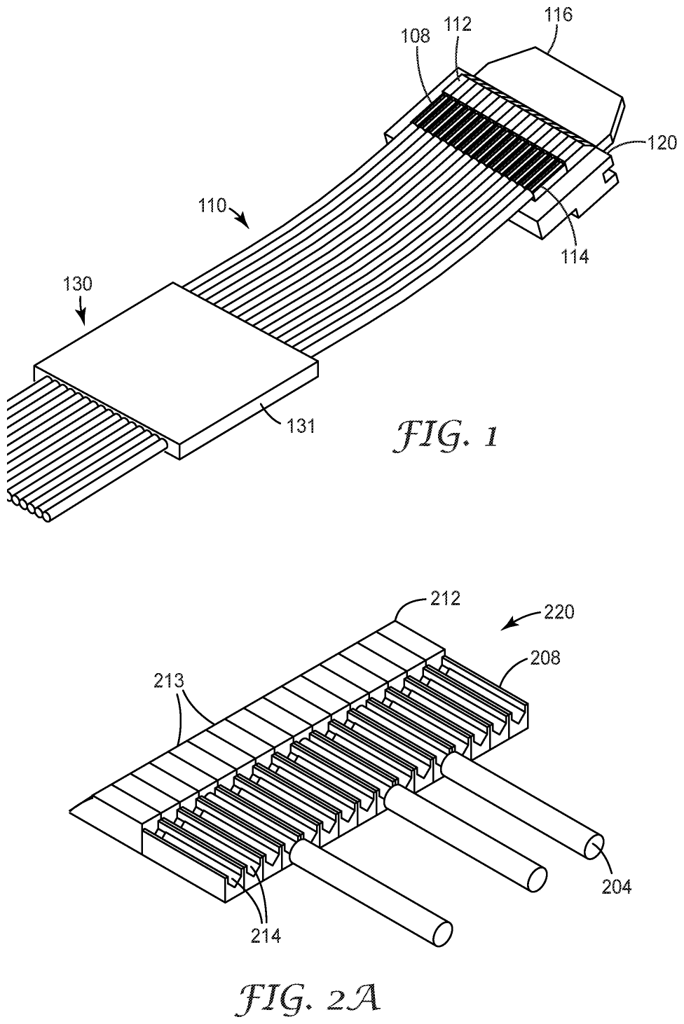

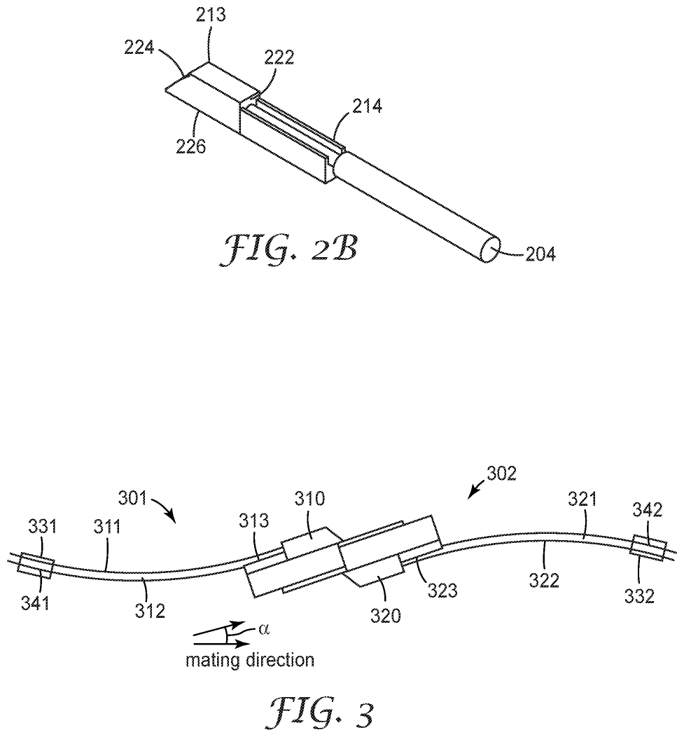

FIG. 2A is a cutaway view of a portion of an optical ferrule 220 showing features of the light redirecting member 212 and waveguide attachment area 208. For convenience, the portion of the ferrule shown in FIG. 2A is referred to as the “top” side of the ferrule 220 and the opposing “bottom” side of the ferrule is not shown in these diagrams. The optical ferrule can be oriented in any position, thus the designations of top side and bottom side are completely arbitrary and are used for ease of identification of the various features of the optical ferrule. FIG. 2A illustrates the attachment of several optical waveguides 204 to ferrule 220 at the attachment area 208. Optical fibers 204 are aligned in grooves 214 to which they are permanently attached. At the point of attachment, the fiber buffer coating and protective jacket (if any) have been stripped away to allow only the bare optical fiber to lie aligned and permanently affixed to groove 214. The exit end of optical fibers 204 is situated so as to be able to direct light emanating from the optical fiber into the input side or face of light redirecting member 212. Light redirecting member 212 includes an array of light redirecting elements 213, at least one for each optical waveguide 204 attached to the optical ferrule 220. For example, in various embodiments each light redirecting element 213 comprises one or more of a prism, a lens, and a reflecting surface. Input light from an optical waveguide is redirected by the light redirecting member and through an optical window (not shown) located on the bottom side of the optical ferrule. The light passes through the optical window and out of the optical ferrule 220.

FIG. 2B is a cutaway view of a portion of an optical ferrule that includes just one light redirecting element 213, one waveguide alignment member, e.g., groove 214, and one optical fiber 204. In this illustration, optical fiber 204 is aligned in groove 214 and may be permanently attached to it. At the point of attachment, the fiber buffer coating and protective jacket (if any) have been stripped away to allow only the bare optical fiber to lie aligned and permanently affixed to groove 214. Light redirecting element 213 includes light input side 222 for receiving input light from first optical waveguide (optical fiber) 204 disposed and aligned at first waveguide alignment member 214. Light redirecting element 213 also includes light redirecting side 224 that may include a curved surface for receiving light from the input side along an input direction and redirecting the received light along a different redirected direction. The light redirecting element 213 also includes output side 226 that receives light from light redirecting side 224 of light redirecting element 213 and transmits the received light as output light along an output direction toward a light redirecting member of a mating light coupling unit.

FIG. 3 illustrates a side view of two optical cable subassemblies 301 and 302 showing mated optical ferrules 310 and 320 attached to optical waveguides 311, 321 at ferrule attachment areas 313, 323. A cable retainer 331, 332 is optionally attached to the optical waveguides 311, 321, at a retainer attachment area 341, 342. The optical ferrules 310, 320 may be oriented at a predetermined mating angle, a, with respect to a mating direction of a connector. A bend 312, 322 in the optical waveguides 311, 321 between the ferrule attachment area 313, 323 and the retainer attachment area 341, 342 (or other attachment area, e.g., in a connector housing) provides a predetermined amount of spring force to maintain the optical ferrules 310, 320 in the mated position.

Additional information regarding features and operation of optical ferrules, optical cable subassemblies and optical connectors is provided in commonly owned U.S. Patent Application 61/710,077 filed on Oct. 5, 2012 which is incorporated herein by reference in its entirety. Additional information regarding features and operation of optical cable retainers is provided in commonly owned U.S. Patent Application Ser. No. 62/240,008 filed on Oct. 12, 2015, and which is incorporated herein by reference in its entirety.

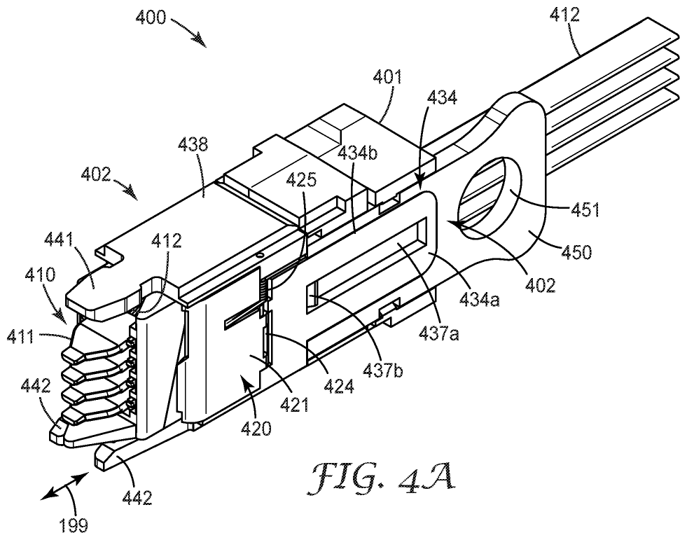

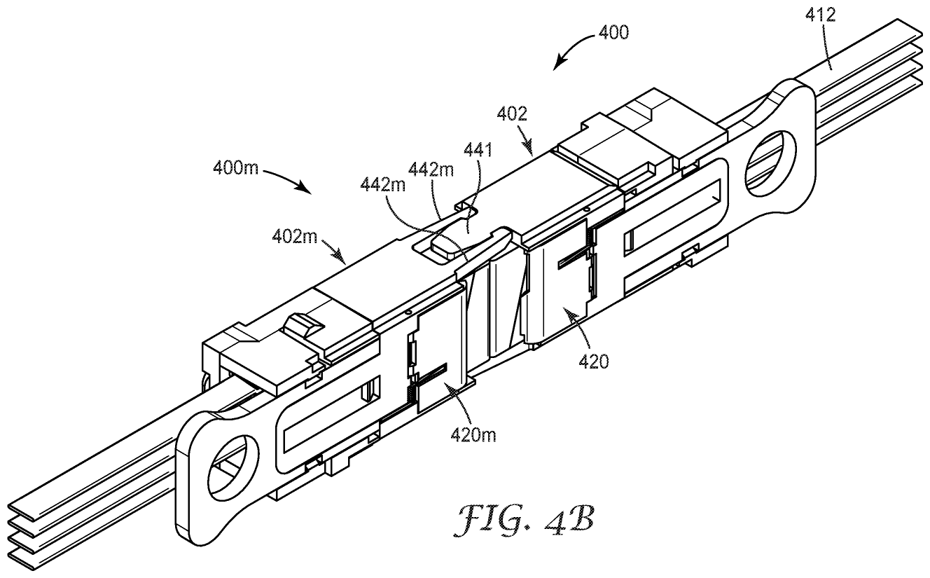

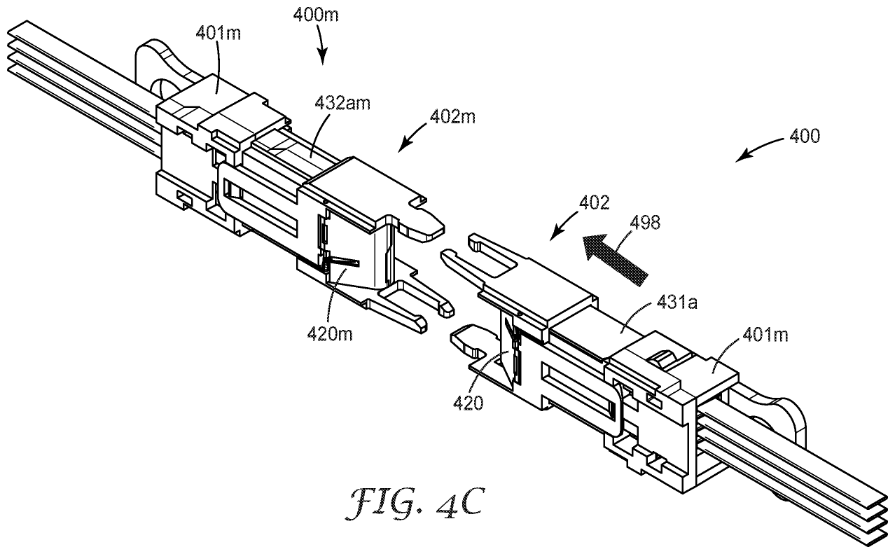

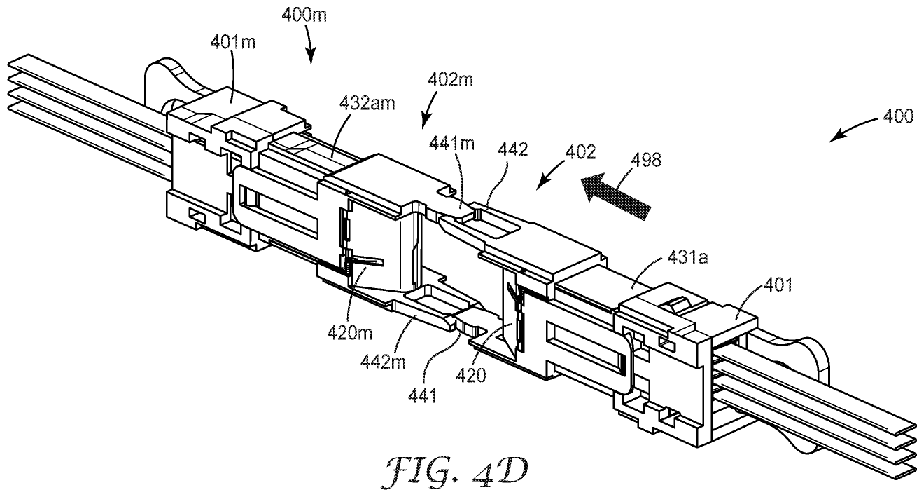

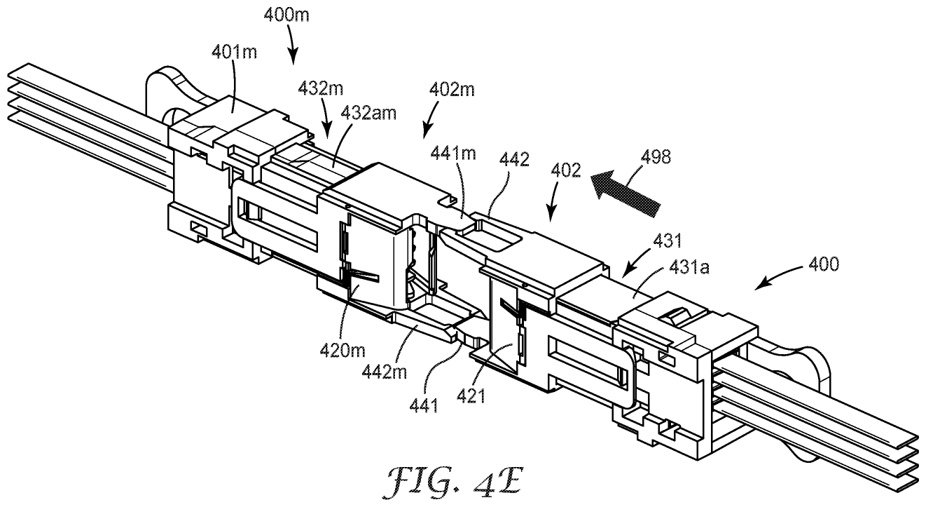

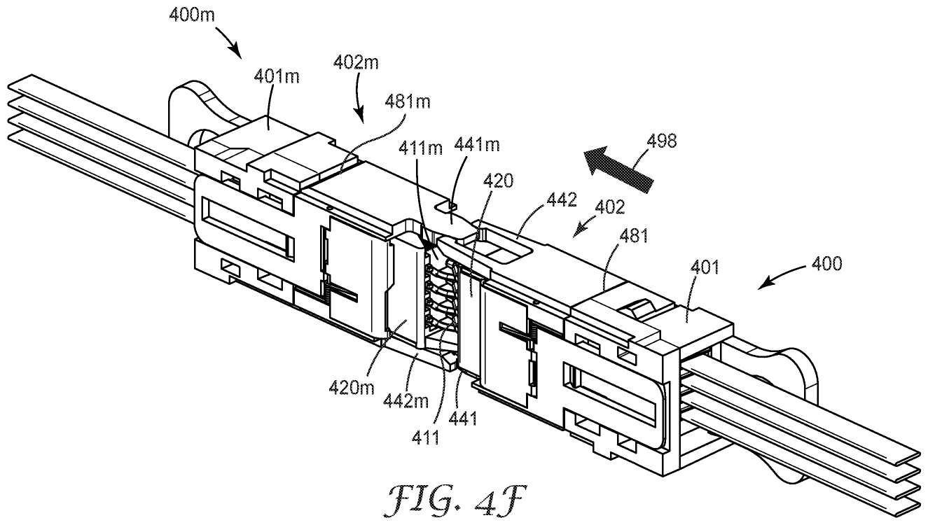

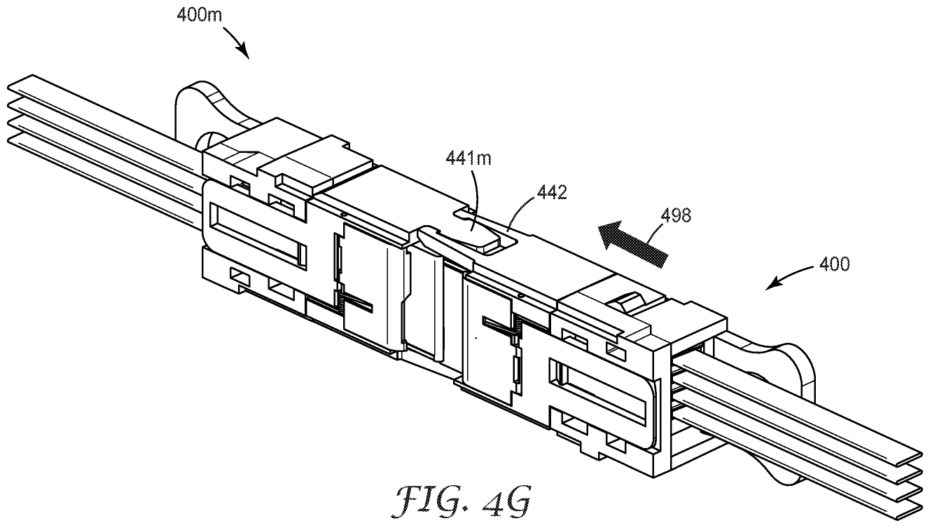

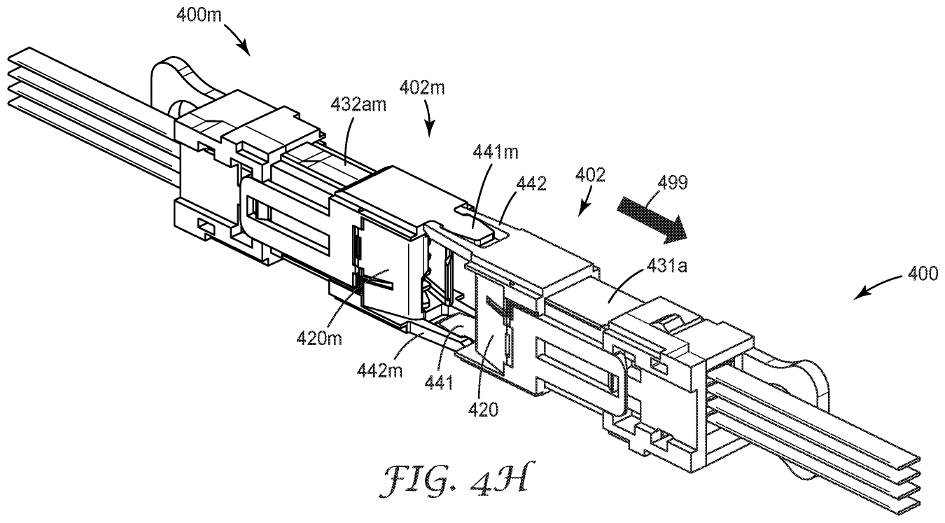

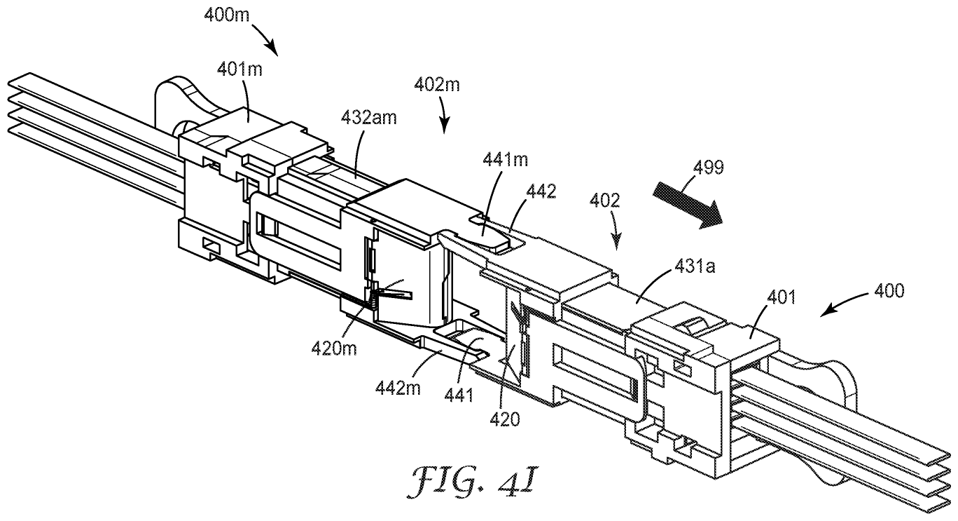

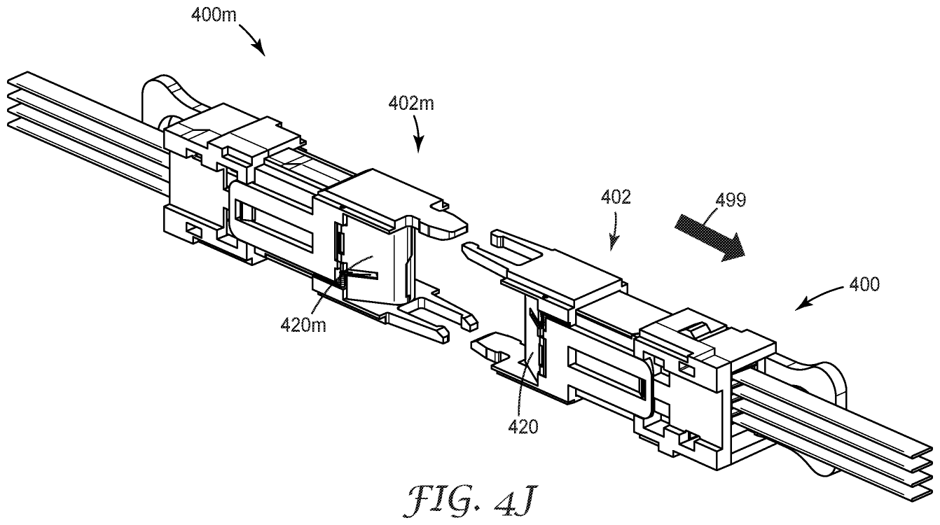

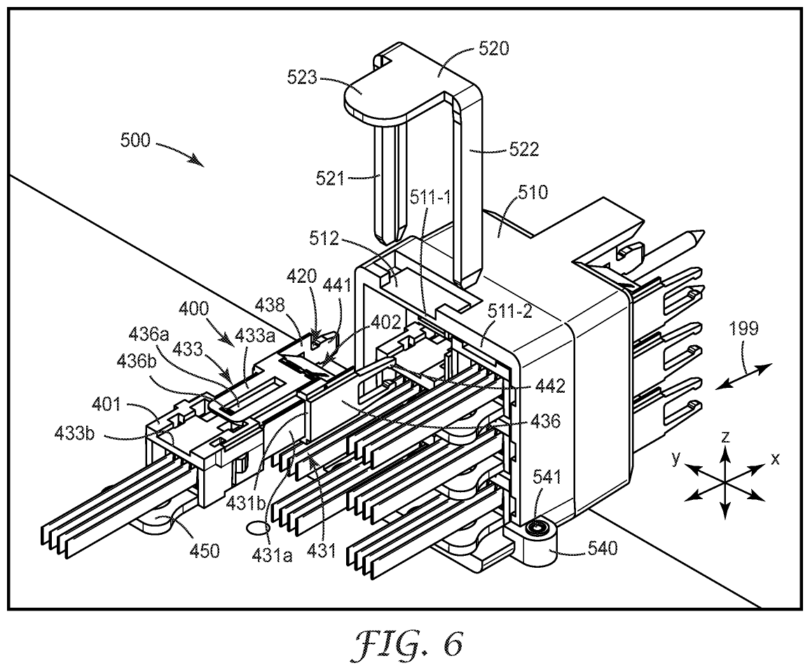

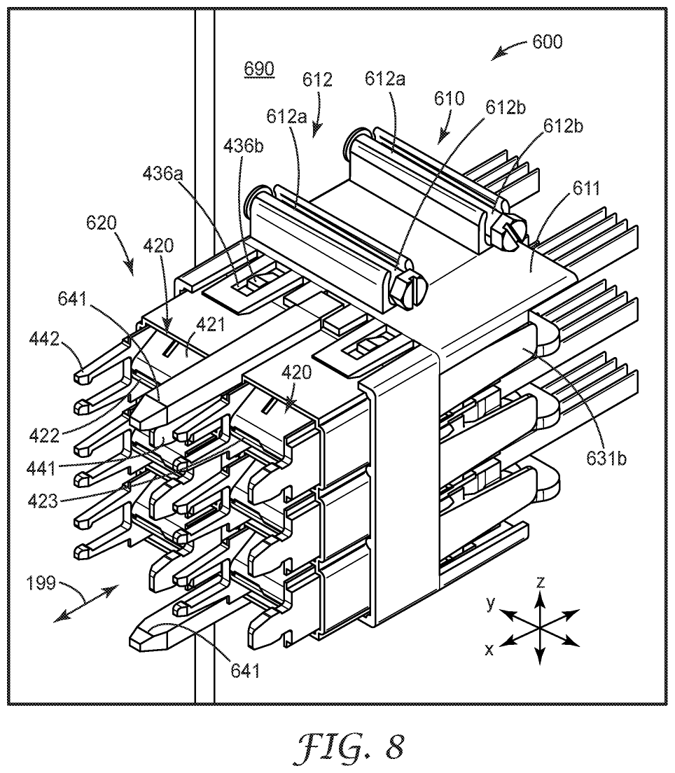

One or more of the optical cable assemblies discussed in FIGS. 1 through 3 above can be assembled into an optical cable subconnector 400, as best seen in FIGS. 4A and 4B as well as FIGS. 6 and 8. The optical cable subconnector 400 comprises a subconnector housing 401 configured to receive and retain one or more optical cable subassemblies 410, wherein each optical cable assembly 410 includes at least one optical ferrule 411 and at least one optical waveguide 412. For example, in the illustrated embodiment, the subconnector housing 401 is configured to receive four optical cable subassemblies 410. In some implementations, the optical subconnector 400 includes a shutter 420 that mechanically protects the optical ferrules 411 and/or reduces the amount of dust that collects on the mating surfaces or optical features of the optical ferrules 411. The shutter 420 is configured to cover the mating ends of the optical ferrules 411. The shutter 420 is operated by a shutter activation mechanism 402 coupled to the shutter 420. As illustrated in FIG. 4B, the shutter activation mechanism 402 is capable of reversibly engaging with a shutter activation mechanism 402m of a mating optical subconnector 400m. In some implementations, the optical subconnector 400 and the mating optical subconnector 400m are hermaphroditic.

The shutter activation mechanism 402 of the optical subconnector 400 is configured such that during mating of the optical subconnector 400 with the mating optical subconnector (not shown), the shutter activation mechanism 402m of a mating optical subconnector 400m pushes the shutter activation mechanism 402 of the optical subconnector 400 along the mating axis 199 of the optical subconnector 100 causing the shutter 420 to open. Simultaneously, the shutter activation mechanism 402 of the optical subconnector 400 pushes the shutter activation mechanism 402m of the mating optical subconnector 400m along the mating axis 199 causing the shutter 420m of the mating optical subconnector 400m to open.

During unmating of the optical subconnector 400 from a mating optical subconnector 400m, the shutter activation mechanism 402m of the mating optical subconnector 400m pulls the shutter activation mechanism 402 of the optical subconnector 400 along a mating axis 199 of the optical subconnector 400 causing the shutter 420 to close. Simultaneously, the shutter activation mechanism 402 of the optical subconnector 400 pulls the shutter activation mechanism 402m of the mating optical subconnector 400m along the mating axis 199 causing the shutter 420m of the mating optical subconnector 400m to close.

In some embodiments, as best seen in FIGS. 4A and 8, the shutter 420 is a two piece shutter comprising a first half 421 and a second half 422. The first half 421 of the shutter is rotatably coupled to the shutter activation mechanism 402 at a first side of the shutter activation mechanism and the second half of the shutter 422 is rotatably coupled to the shutter activation mechanism 402 at an opposing second side of the shutter activation mechanism 402. In some embodiments, the rotatable coupling 424 between the one or both of the shutter halves 421, 422 and the housing 401 may be spring-loaded by a bias spring 425 to facilitate closing the shutter 420 during unmating. The bias spring may be located at various locations. In the illustrated embodiment, the bias spring is located at the rotatable coupling. For example, the bias spring may be centrally located along the rotatable coupling or may be offset, as shown.

During mating, the first and second shutter halves 421, 422 are configured to rotate around the y axis as the shutter activation mechanism 402 moves back over the subconnector housing 401 and away from the mating connector. The first and second shutter halves 421, 422 slide over opposing first and second sides of the subconnector housing 401 as they move back along the x-axis. As illustrated, the shutter 420 may be a clamshell shutter comprising a first half shell 421 and a second half shell 422. Each of the first and second half shells 421, 422 are rotatably attached to the shutter activation mechanism 402. When the shutter 420 is closed, the first and second half shells 421, 422 extend along the mating axis away from their rotatable coupling 424 with the shutter activation mechanism 402 and meet at a vertex 423. The shutter activation mechanism 402 is configured to cause the each of the first and second half shells 421, 422 to rotate around the y axis at the rotatable coupling 424, part at the vertex 423, and then move along the mating axis 199 over the subconnector housing in a direction away from the mating connector as the optical subconnector 400 mates with a mating optical subconnector.

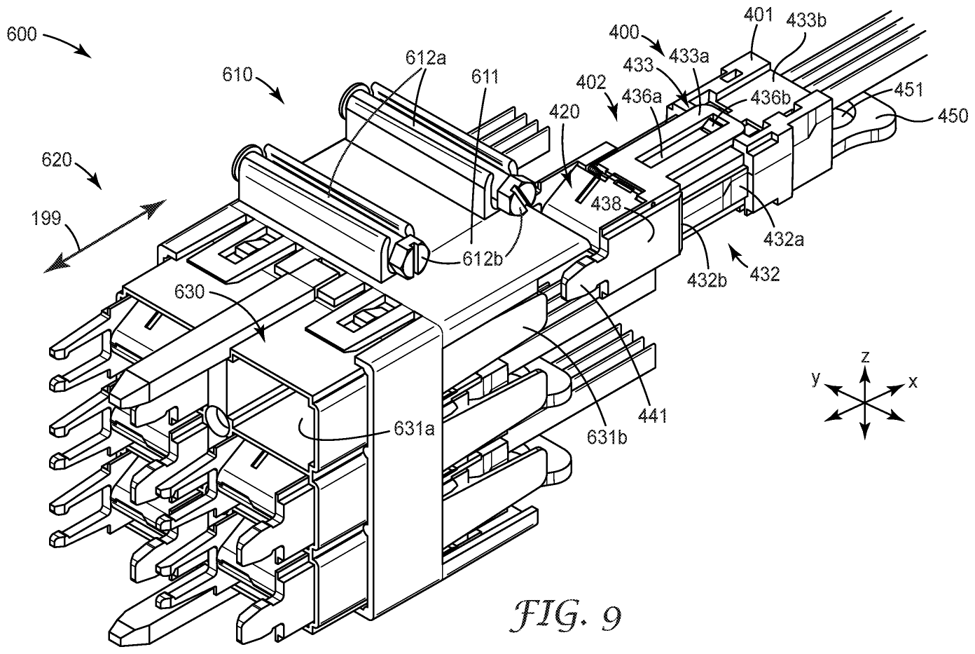

Referring to FIGS. 4A, 6 and 9, the shutter activation mechanism 402 is attached to the subconnector housing 401 by one or more slidable couplings 431, 432, 433, 434 As best seen in FIGS. 6 and 9, each of the slidable coupling 431, 432, 433, 434 may comprise a channel and rail coupling. As in FIGS. 6 and 8, a slidable coupling 431, 432 may be disposed on first and second opposing sides of the optical subconnector 400. As illustrated in FIG. 6 slidable coupling 431 includes a rail 431a disposed on the subconnector housing 401 and a channel 431b in a channel member 436 of the shutter activation mechanism 402. As illustrated in FIG. 9, slidable coupling 432 includes a rail 432a disposed on the subconnector housing 401 and a channel 432b disposed in a channel member 438 of the shutter activation mechanism. Alternatively, the opposite configuration is possible for the slidable coupling wherein the channel members and channels are disposed on the subconnector housing and the rails are disposed on the shutter activation mechanism.

Slidable couplings 433, 434 between the shutter activation mechanism 402 and the housing 401 may also be disposed on the top side and/or bottom side of the optical subconnector 400. For convenience, the portion of the optical subconnector 400 visible in FIGS. 6 and 9 is referred to as the “top” side of the optical subconnector 400 and the opposing “bottom” side of the optical subconnector 400 is visible in FIG. 4A. The optical subconnector can be oriented in any position, thus the designations of top side and bottom side are completely arbitrary and are used here for identification purposes only. The slidable couplings 433, 434 may also be slidable channel and rail couplings wherein the channel 433b, 434b is formed in the subconnector housing 401 and the rail 433a, 434a is part of the shutter activation mechanism 402. According to some implementations, the rail 433a, 434a of the shutter activation mechanism 402 includes a slot 436a, 437a that is configured to engage with a peg 436b, 437b on the subconnector housing 401 such that the peg 436b, 437b fits within the slot 436a, 437a. The peg 436b, 437b and slot 436a, 437a limit the motion of the shutter activation mechanism 402 relative to the subconnector housing 401 along the mating axis 199. Alternatively or additionally, the channels 431b, 432b, 433b, 434b and rails 431a, 432a, 433a, 434a may include stop features that limit the motion of the shutter activation mechanism 402 along the mating axis 199.

The shutter activation mechanism 402 of the optical subconnector 100 is discussed with reference to FIGS. 4A, 6, 8, and 9. The shutter activation mechanism 402 comprises features that can engage upon mating and stay engaged during unmating long enough to pull the shutters 420 forward allowing the shutters 420 to close over the optical ferrules 411.

During mating, the shutters 420 are pushed back and over the subconnector housing 401. During unmating, the shutters 420 are pulled forward allowing them to close over the optical ferrules 411. The shutters 420 may include a spring loaded closing mechanism comprising a rotatable coupling 424 with a bias spring 425 to assist with the closing of the shutters 420.

The shutter activation mechanism 402 may be hermaphroditic, as illustrated in FIG. 4B such that both the shutter activation mechanism 402 of the optical subconnector 400 and the shutter activation mechanism 402m of the mating optical subconnector 400m have identical engagement features 441, 442m. The features 441 of the shutter activation mechanism 402 of the optical subconnector 400 engage with complementary engagement features 442m of the shutter activation mechanism 402m of the mating optical subconnector 400m when the orientation of the optical subconnector 400 is reversed with respect to the orientation of the mating optical subconnector 400m.

In the embodiments shown in FIGS. 4A, 4B, 5, 6, 8, and 9, the shutter activation mechanism 402 includes a paddle engagement feature 441 disposed at one side of the optical subconnector housing 401 and one or more hook engagement features 442 disposed at the other side of the optical subconnector housing 401. The paddle 441 is configured to be captured by the hooks 442m of the shutter activation mechanism of the mating optical subconnector 400m during mating. The hooks 442 are configured to capture a paddle of the shutter activation mechanism 402m of the mating optical subconnector during mating. During mating, the hooks 442 of the shutter activation mechanism 402 deflect along the z axis to capture the paddle of the shutter assembly of the mating optical subconnector 400m. During unmating, after or as the shutters 420 are pulled closed, the hooks 442 deflect again along the z axis to release the paddle of the shutter assembly of the mating optical subconnector. The hooks 442 extend from channel member 436 on one side of the shutter activation mechanism 402 and the paddle 441 extends from a channel member 438 on the opposing side of the shutter activation mechanism 402.

The optical subconnector may optionally include an extraction tab 450 that includes a finger loop 451 to facilitate inserting and removing the optical subconnector from the carrier.

FIGS. 4C through 4G are a sequence of diagrams that show the optical subconnector 400 and mating optical subconnector 400m during the process of mating. FIG. 4C shows the optical subconnector 400 and the mating optical subconnector 400m as the optical subconnector 400 is approaching the mating optical subconnector 400m along the mating direction 498 and before the shutter activation mechanisms 402, 402m of the optical subconnectors 400, 400m make contact. The shutters 420, 420m are closed. The shutter activation mechanisms 402, 402m of both optical subconnectors 400, 400m are fully extended along the rails 431a, 432am of the housings 401, 401m.

FIG. 4D shows the optical subconnector 400 and mating optical subconnector 400m after the optical subconnector 400 has moved further along the mating direction 498. The respective shutter activation mechanisms 402, 402m are just touching but are not yet engaged. The hooks 442 of the optical subconnector 400 are touching the paddle 441m of the mating optical subconnector 400m. The paddle 441 of the optical subconnector 400 is touching the hooks 442m of the mating optical subconnector 400m. The shutters 420, 420m are closed. The shutter activation mechanisms 402, 402m of both optical subconnectors 400, 400m are fully extended along the rails 431a, 432am of the housings 401, 401m.

FIG. 4E shows the optical subconnector 400 and mating optical subconnector 400m as the optical subconnector 400 moves further along the mating direction 498. The shutter activation mechanism 402 of the optical subconnector 400 has started to push the shutter activation mechanism 402m of the mating optical subconnector 400m along the rail 432am of the rail and channel coupling 432m. The shutter activation mechanism 402m of the mating optical subconnector 400m has begun to push the shutter activation mechanism 402 of the optical subconnector along the rail 431a of the rail and channel coupling 431. As the shutter activation mechanisms 402, 402m move along the rails 432am, 431a, the shutters 420, 420m are pulled over the subconnector housings 401, 401m.

FIG. 4F shows the optical subconnector 400 and mating optical subconnector 400m as the optical subconnector 400 moves further along the mating direction 498. The shutter activation mechanism 402 of the optical subconnector 400 is pushed against the stop 481 of the optical subconnector housing 401 and the shutter activation mechanism 402m of the mating optical subconnector 400m is pushed against the stop 481m of the mating optical subconnector housing 401m. The shutters 420, 420m are deployed over their respective subconnector housings 401, 401m and the ferrules 411, 411m are exposed.

FIG. 4G shows the optical subconnector 400 and mating optical subconnector 400m when they are fully mated. The shutter activation mechanism 402 of the optical subconnector 400 is engaged with the shutter activation mechanism 402m of the mating optical subconnector 400m. The paddle 441m of the mating shutter activation mechanism 402m has been captured by hooks 442 of the shutter activation mechanism 402.

FIGS. 4H through 4J are a sequence of diagrams that show the optical subconnector 400 and the mating optical subconnector 400m during the process of unmating. FIG. 4H shows the optical subconnector 400, 400m as the optical subconnector 400 moves along the unmating direction 499. The paddle 441m of the mating shutter activation mechanism 402m is still captured by the hooks 442 and the paddle 441 of the shutter activation mechanism 402 is still captured by the hooks 442m of the mating shutter activation mechanism 402m. The shutter activation mechanisms 402, 402m are extended along the rails 431a, 432am of the subconnector housings 401, 401m. The shutters 420, 420m are starting to close.

FIG. 4I shows the optical subconnector 400, 400m as the optical subconnector 400 moves further along the unmating direction 499. The paddle 441m of the mating shutter activation mechanism 402m is still captured by the hooks 442 and the paddle 441 of the shutter activation mechanism 402 is still captured by the hooks 442m of the mating shutter activation mechanism 402m. The shutter activation mechanisms 402, 402m are extended along the rails 431a, 432am of the subconnector housings 401, 401m. The shutters 420, 420m are closed.

FIG. 4J shows the optical subconnector 400, 400m after unmating. The paddle 441m of the mating shutter activation mechanism 402m is disengaged from the hooks 442 and the paddle 441 of the shutter activation mechanism 402 is disengaged from the hooks 442m of the mating shutter activation mechanism 402m. The shutter activation mechanisms 402, 402m are fully extended along the rails 431a, 432am of the subconnector housings 401, 401m. The shutters 420, 420m are closed.

As shown in FIGS. 4C through 4J the shutter activation mechanism 402, 402m has a wider tongue (paddle 441) on one side and a matching groove, formed of two narrower tongues (hooks 442, 442m) on the other. When the two opposing subconnectors 400, 400m engage, the two narrow tongues (hooks 442, 442m) on each shutter activation mechanism 402, 402m deflect outward allowing the wider tongues (paddles 441, 441m) to enter the opposing grooves formed by the narrower tongues (hooks 442, 442m).

The two mated shutter activation mechanisms 402, 402m then allow the opposing subconnector housings 401, 401m to slide forward, opening the shutters 420, 420m and pressing the enclosed ferrules 411, 411m into optical connection.

The wider tongues (paddles 441, 441m) and their matching grooves formed by two opposing hooks (442, 442m) remain interconnected until the connectors 400, 400m are umnated, at which time the intermated features 441, 441, 442, 442m pull the shutter activation mechanisms 402, 402m forward relative to the subconnector housings 401, 401m closing the shutters 420, 420m. The narrow tongues (hooks 442, 442m) then once again deflect and allow the wider tongues (paddles 441, 441m) to slide free from their grooves, completing the unmating of the subconnectors 400, 400m.

Some embodiments are directed to an optical connector that includes multiple optical subconnectors and at least first and second housing components wherein control of x, y, and z translation of the multiple optical subconnectors is distributed between the first and second housing components. Each housing component controls movement of all of the multiple optical subconnectors along at least one but not all of the x, y, and z axes. For example, in some embodiments, the first housing component is a carrier that controls movement of the optical subconnectors along the y and z axes and the second housing component is a movement control component that controls movement of all of the multiple optical subconnectors along a mating axis (x-axis) of the optical connector. The movement control provided by the second housing component controls movement of all of the multiple optical subconnectors such that none of the multiple optical subconnectors can move independently of the other optical subconnectors.

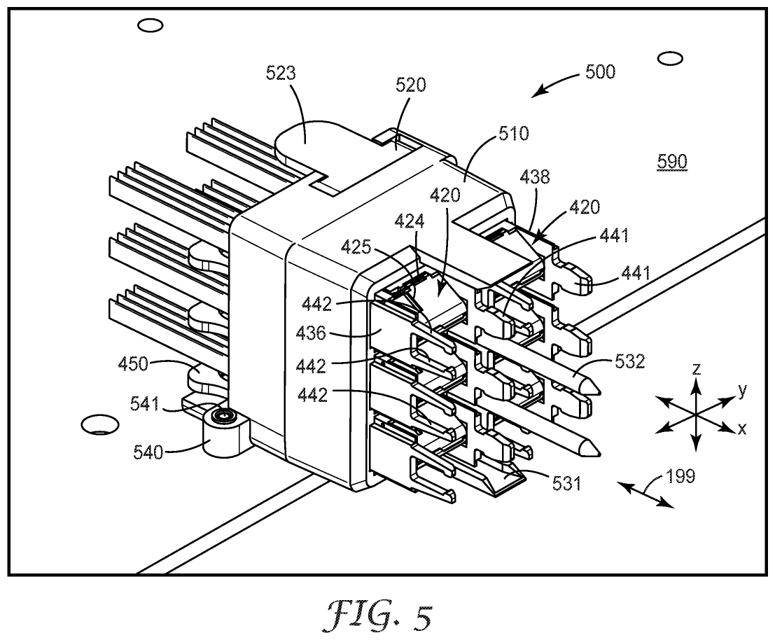

FIGS. 5, 6, and 7 illustrate one example of such an optical connector 500 in accordance with some embodiments. In this example, the optical connector 500 includes two housing components 510, 520, wherein control of the x, y, and z translation of the multiple optical subconnectors 400 is distributed between the first and second housing components 510, 520.

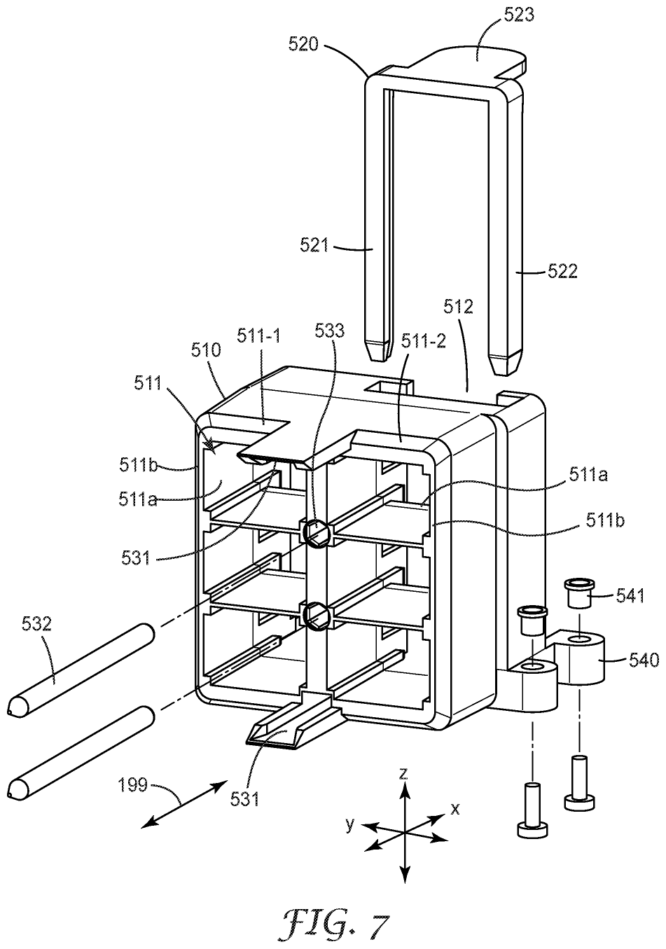

FIG. 5 provides a perspective view of optical connector 500, FIG. 6 provides an exploded perspective view of the optical connector 500, and FIG. 7 shows the first 510 and second housing components 520. Connector 500 includes multiple optical subconnectors 400 wherein each of the multiple optical subconnectors 400 include a subconnector housing 401 and a one or more optical cable assemblies 410. Each optical cable assembly 410 comprises at least one optical ferrule 411 and at least one optical waveguide 412 attached to the ferrule 411.

The first housing component 510, also referred to herein as the carrier, of optical connector 500 is configured to receive the multiple optical subconnectors 400. The carrier 510 controls translational movement of the multiple optical subconnectors 400 along the y and z axes. In this example, the first housing component 510 restricts movement of the multiple optical subconnectors 400 within the first housing component 510 along the y and z axes.

A second housing component 520 is configured to be assembled with the first housing component 510 by removable insertion into the first housing component 510. For example, the second housing component 520 may be inserted along any axis, for example, along an axis different from the mating axis, or as another example, generally along the z axis as shown in FIG. 5. When the second housing component 520 is inserted into the first housing component 510, the second housing component 520 serves as a movement control component that controls movement of the multiple optical subconnectors 400 within the first housing 510 along the x axis, which is the mating axis.

As best seen in FIG. 7, first housing component 510, also referred to herein as the carrier includes multiple compartments 511. Each compartment has a cavity 511a defined by one or more walls 51 lb such that the compartment 511 is configured to receive one of the multiple optical subconnectors 400. As illustrated in FIGS. 5 and 6, the compartments 511 may be arranged in a two column array. Referring to FIGS. 6 and 7, the first 511-1 and second 511-2 columns of the array each include three compartments. The optical subconnectors 400 are configured to be inserted into the compartments 511 along the mating axis 199.

The second housing component 520, also referred to herein as the retaining clip, is configured to retain the multiple optical subconnectors 400 within the compartments 511 of the carrier 510. As seen in FIGS. 6 and 7, the retaining clip 520 includes multiple pins 521, 522. The retaining clip 520 is configured to fit within an offset slot 512 within the carrier 510. The offset slot 512 is offset in the lateral y direction from the center z axis of the connector. Each pin 521, 522 is configured to retain a column of the optical subconnectors 400 within their respective compartment 511 of the carrier 510. The pins 521, 522 are configured to engage with sides of the multiple optical subconnectors 400 so as to retain each of the multiple optical subconnectors 400 within their respective compartment 511. As best seen in FIGS. 6 and 7, when the retaining clip 520 is inserted into the carrier 510, the top of the retaining pin 520 fits within the offset slot 512. The first pin 521 of the retaining clip 520 is configured to engage with a first side of the optical subconnectors 400 disposed within the cavities 511 of the first column 511-1 of compartments. The second pin 522 of the retaining clip 520 is configured to engage with a first side of the optical subconnectors 400 disposed within the cavities 511 of the second column 511-2 of compartments. The retaining clip 520 may include a tab 523 that facilitates removal and insertion of the retaining clip 520 into and from the carrier 510 along the z axis.

The connector 500 further can additionally include fixed mounting bosses 540 and threaded insert fasteners 541 disposed on either side of the carrier 510 and configured to facilitate mounting the connector 500 on a substrate 590. The carrier 510 may also include one or more alignment features allowing the connector 500 to be aligned with a mating connector, such as connector 600 shown in FIGS. 8, 9, 10, and 11. For example, the alignment features may include one or more guide slots 531 projecting from two major surfaces of the carrier 510 along the x axis. Each guide slot 531 is configured to receive a guide key 641 of a mating connector 600.

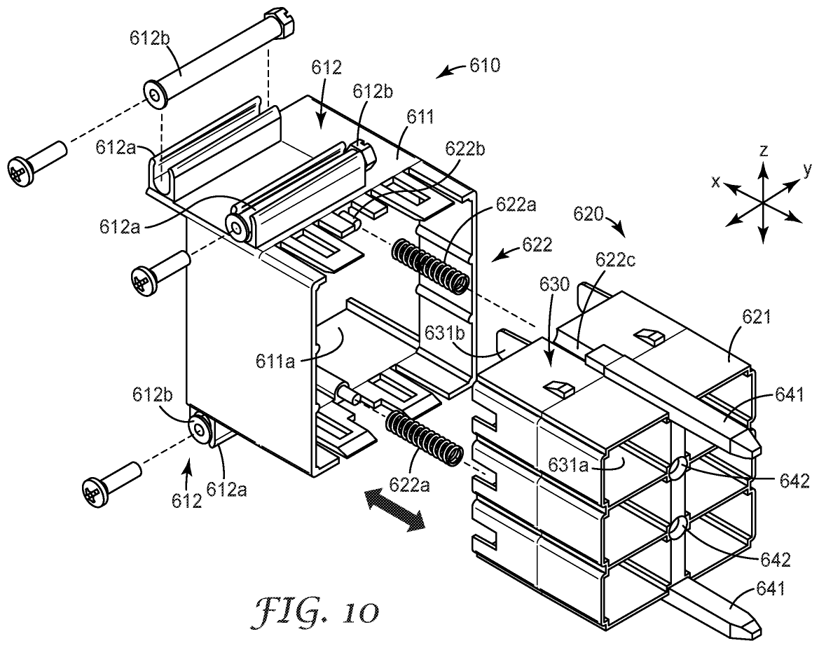

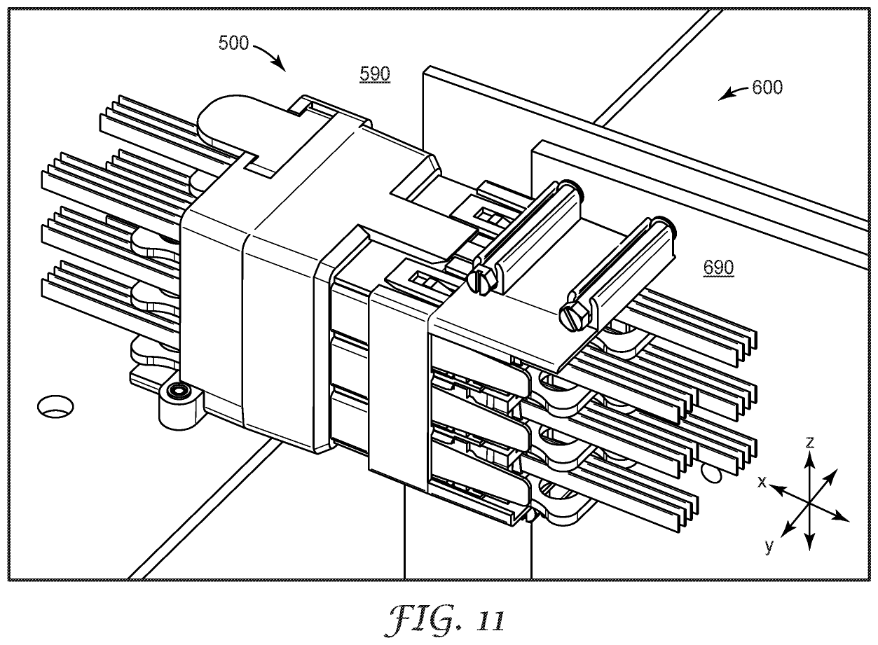

The alignment features may include one or more guide pins 532 disposed between the guide slots 531 along the center line of the carrier 510 along the z axis and extending from the carrier 510 along the x axis. For example, the guide pins 532 may comprise pins made of metal or other material that are fitted into holes 533 molded in the carrier 510 as best seen in FIG. 7. The guide pins 532 are configured to be inserted into guide holes 642 of optical connector 600 shown in FIG. 10, for example.

FIGS. 8, 9, and 10 illustrate another example of an optical connector 600 which includes two or more housing components 610, 620, wherein control of the x, y, and z translation of multiple optical subconnectors 400 is distributed between the first and second housing components 610, 620.

FIGS. 8 and 9 are perspective views of the connector 600 and FIG. 10 is an exploded perspective view showing the first and second housing components 610, 620. The first housing component 610 of connector 600 includes a base housing 611 and a slidable coupling 612 that couples the base housing 611 to a mounting substrate 690. The slidable coupling 612 provides for limited movement of the optical subconnectors 400 along the y and z axes. In this example, as shown in FIGS. 8, 9, and 10, the slidable coupling 612 comprises one or more elongated slots 612a disposed on a surface of the base housing 611. The slots 612a are configured to retain posts 612b that are attached to a substrate 690. The slots 612a are generally oval in cross section and the dimensions of the slots 612a are larger than the dimensions of the posts 612b along the y and z directions. The shafts of the posts 612b are longer than the slots 612a in the y direction. This difference in length is the allowed translational movement in the y direction. The dimension of the slots 612a in the x direction is matched to the dimension of the posts 612b within some tolerance. The mismatch in dimensions between the slots 612a and posts 612b along the y and z axes allows a limited amount of translational movement of the base housing 611 along the y and z axes when the base housing 611 is attached to the substrate 690. The slots 612a are generally oval in cross section and the dimensions of the slots 612a are larger than the dimensions of the posts 612b along the y and z directions.

The amount of translation in the y and/or z directions may vary based on implementation. The amount of translation in the y direction is determined by the depth of the slot in the y direction. The amount of translation in the z direction is determined by the length of the long axis of the oval cross section of the slot. In general, the amount of translation provided by the slots is less than about 5 mm in the y and/or z directions.

The second housing component 620 of connector 600 includes a carrier 621 and a float coupling 622 that couples the carrier 621 to the base housing 611. The carrier 621 includes multiple compartments 630 and fits inside a cavity 611a of the base housing 611. Each compartment 630 includes a cavity 631a dimensioned to receive one of the multiple optical subconnectors 400 and a compartment latch 631b. A compartment latch 631b is disposed at at least one side of each cavity 631a and is configured to engage with the subconnector housing 401 to retain the optical subconnector 400 within the cavity 631.

The float coupling 622 serves as a movement control component that controls movement of the multiple optical subconnectors 400 along a mating axis 199 of the optical connector. In the illustrated embodiment, the float coupling 622 can include one or more springs 622a coupled between the base housing 611 and the carrier 621. As best seen in FIG. 10, the float coupling 622 further includes a peg 622b on the base housing and a channel 622c on the carrier 621. One end of the spring 622a fits over the peg 622b of the base housing 611 and the other end of the spring 622a fits inside the channel 622c of the carrier 621. The float coupling 622 may take other forms, such as an elastomeric material disposed between the base housing and the carrier. The float coupling 622 also provides a controlled amount of mating force between connector 500 and the mating connector 600. The float coupling 622 allows a simultaneous translational movement of the carrier 621 and all of the optical subconnectors 400 disposed within the carrier 621 along the x axis, which is the mating axis 199 of the optical connector 600. The float coupling allows a controlled amount of translation of the carrier 621 and all of the optical subconnectors 400. The amount of translation along the x axis may differ depending on application. The amount of translation may be changed by altering the design of the base housing 611, the carrier 621, and/or the springs 622a. In general, the amount of translation can be less than about 10 mm in the x direction in many embodiments.

The connector 600 may also include one or more alignment features allowing the connector 600 to be aligned with a mating connector, such as connector 500 shown in FIGS. 5, 6, 7 and 11. For example, the alignment features may include one or more guide keys 641 projecting from two major surfaces of the carrier 621 along the x axis. Each guide key 641 is configured to fit within a guide slot 531 of a mating connector 500.

The alignment features may include one or more guide holes 642 disposed between the guide keys 641 along the z axis in FIG. 10 and extending from the carrier 621 along the x axis. The guide holes 642 are configured to engage with the guide pins 532 of the carrier 511 of a mating connector 500.

FIG. 11 illustrates a connector assembly 700 comprising the optical connector 500 and optical connector 600 as discussed above after mating. Connector 500 is mounted on horizontal substrate 590 and connector 600 is mounted on vertical substrate 690.

Items described in this disclosure include:

Item 1. An optical subconnector comprising:

a subconnector housing;

one or more optical cable assemblies disposed within the subconnector housing, each optical cable assembly comprising at least one optical ferrule and at least one optical waveguide;

a shutter that covers mating ends of the optical ferrules; and

a shutter activation mechanism coupled to the shutter and configured to reversibly engage with a shutter activation mechanism of a mating optical subconnector such that during unmating of the optical subconnector and the mating optical subconnector, the shutter activation mechanism of the mating optical subconnector pulls the shutter activation mechanism of the optical subconnector along a mating axis of the optical subconnector causing the shutter to close.

Item 2. The optical subconnector of item 1, wherein the shutter activation mechanism is configured to engage with the shutter activation mechanism of the mating optical connector during mating such that during mating of the optical connector with the mating optical connector:

the shutter activation mechanism of the mating optical connector pushes the shutter activation mechanism of the mating optical connector along the mating axis causing the shutter to open; and

the shutter activation mechanism of the connector pushes the shutter activation mechanism of the mating optical connector open along the mating axis causing the shutter of the mating optical connector to open.

Item 3. The optical subconnector of any of items 1 through 2, wherein the shutter activation mechanism is configured to move relative to the subconnector housing during mating and unmating.
Item 4. The optical subconnector of any of items 1 through 3, wherein the shutter is a two piece shutter comprising a first half and a second half.
Item 5. The optical subconnector of item 4, wherein;

the first half of the shutter is rotatably attached to the shutter activation mechanism at a first side of the subconnector housing; and

the second half of the shutter is rotatably attached to the shutter activation mechanism at an opposing second side of the subconnector housing.

Item 6. The optical subconnector of item 5, wherein:

the first half of the shutter is configured to slide over the first side of the subconnector housing during mating; and

the second half of the shutter is configured to slide over the second side of the subconnector housing during mating.

Item 7. The optical subconnector of any of items 1 through 6, wherein the shutter is a clamshell shutter comprising:

a first half shell; and

a second half shell, each of the first and second half shells rotatably attached to the shutter activation mechanism, the first and second half shells configured to extend along the mating axis and meet at a vertex when the shutter is closed.

Item 8. The subconnector of item 7, wherein first and second half shells are configured to rotate and part when the shutter opens.
Item 9. The optical subconnector of any of items 1 through 8, wherein the shutter activation mechanism is attached to the subconnector housing by at least one slidable attachment.
Item 10. The optical subconnector of item 9, wherein the at least one slidable attachment includes at least one channel and rail attachment.
Item 11. The optical subconnector of item 9, wherein the at least one slidable attachment includes:

a first channel and rail slidable attachment disposed on one a first side of the optical subconnector; and

a second channel and rail slidable attachment disposed on an opposing second side of the optical subconnector.

Item 12. The optical subconnector any of items 1 through 11, wherein the shutter activation mechanism comprises:

a paddle disposed at one side of the optical subconnector, the paddle configured to be captured by one or more hooks of the shutter activation mechanism of the mating optical subconnector during mating of the optical subconnector and the mating optical subconnector; and

one or more hooks disposed at an opposite side of the optical subconnector, the one or more hooks configured to capture a paddle of the shutter activation mechanism of the mating optical subconnector during mating of the optical subconnector and the mating optical subconnector.

Item 13. The optical subconnector of item 12, wherein the hooks are configured such that:

during mating the hooks of the optical subconnector deflect to capture the paddle of the mating optical subconnector; and

during unmating the hooks of the optical subconnector deflect to release the paddle of the mating optical subconnector.

Item 14. The optical subconnector of item 12, wherein the shutter activation mechanism comprises:

a first channel member comprising a first channel configured to slidably engage with a first rail of the subconnector housing, the paddle extending from the first channel member along the mating direction; and

a second channel member comprising a second channel configured to slidably engage with a second rail of the subconnector housing, the hooks extending from the second channel member along the mating direction.

Item 15. The optical subconnector of any of items 1 through 14, wherein:

the subconnector housing is coupled to the shutter activation mechanism by a rail and channel coupling on multiple sides of the subconnector housing;

at least one of the rail and channel couplings includes a rail of the shutter activation mechanism that slides in a channel of the subconnector housing, wherein the rail of the shutter activation mechanism includes a slot and the channel of the subconnector housing includes a peg that fits inside the slot.

Item 16. The optical subconnector of item 15, wherein the peg and slot limit motion of the shutter activation mechanism relative to the subconnector housing along the mating axis.
Item 17. The optical subconnector of any of items 1 through 16, wherein the shutter activation mechanism is hermaphroditic.
Item 18. An optical connector comprising:

a housing;

one or more optical subconnectors disposed within the housing, each optical subconnector comprising:
a subconnector housing;
one or more optical cable assemblies disposed within the subconnector housing, each optical cable assembly comprising at least one optical ferrule and at least one optical waveguide;

a shutter that covers mating ends of the optical ferrules; and

a shutter activation mechanism coupled to the shutter and configured to reversibly engage with a shutter activation mechanism of a mating optical subconnector such that during unmating of the optical subconnector and the mating optical subconnector, the shutter activation mechanism of the mating optical subconnector pulls the shutter activation mechanism of the optical subconnector along a mating axis of the optical connector causing the shutter to close.

Item 19. The optical connector of item 18, wherein the housing comprises a carrier having one or more compartments, each compartment including a cavity configured to respectively accept one of the optical subconnectors.
Item 20. The optical connector of item 19, wherein each compartment includes a latch that secures a subconnector housing of the optical subconnectors in its respective cavity.
Item 21. The optical connector of item 19, further comprising a retaining clip that secures all the subconnector housings of the one or more optical subconnectors in their respective cavities.
Item 22. An optical connector comprising:

a carrier;

multiple optical subconnectors disposed within the carrier, each optical subconnector comprising:
a subconnector housing; and
one or more optical cable assemblies, each optical cable assembly comprising at least one optical ferrule and at least one waveguide; and

a movement control component separable from the multiple optical subconnectors and the carrier, the movement control component configured to control movement of the multiple optical subconnectors along a mating axis of the optical connector.

Item 23. The optical connector of item 22, wherein the movement control component is a retaining clip that substantially prevents movement of all of the optical subconnectors along the mating axis.
Item 24. The optical connector of item 23 wherein the retaining clip is configured to be inserted into the carrier along an axis perpendicular to the mating axis.
Item 25. The optical connector of item 24, wherein the carrier includes multiple compartments, each compartment having a cavity configured to receive one of the multiple optical subconnectors.
Item 26. The optical connector of item 25, wherein:

the compartments are arranged in columns; and

the retaining clip one or more pins, each pin configured to secure a column of optical subconnectors within their respective cavities.

Item 27. The optical connector of any of items 22 through 26, wherein the movement control component simultaneously controls movement of all of the multiple optical subconnectors.
Item 28. The optical connector of any of items 22 through 27, further comprising a base housing, the carrier configured to fit at least partially within the base housing, wherein the movement control component comprises a float coupling that couples the carrier to the base housing, the float coupling allowing limited movement of the carrier and the multiple optical subconnectors along the mating axis.
Item 29. The optical connector of item 28, wherein the carrier comprises multiple compartments, each compartment having a cavity configured to receive one of the multiple optical subconnectors.
Item 30. The optical connector of item 29, wherein each compartment includes a latch, the latch configured to secure the optical subconnector within the cavity of the compartment.
Item 31. An optical connector comprising:

multiple optical subconnectors, each optical subconnector comprising:
a subconnector housing; and
one or more optical cable assemblies, each optical cable assembly comprising at least one optical ferrule and at least one optical waveguide;

two or more housing components, comprising at least:
a first housing component; and
a second housing component, wherein control of x, y, and z translation of the multiple optical subconnectors is distributed between the first and second housing components such that each housing component controls movement of the optical subconnectors along at least one but not all of the x, y, and z axes.
   Item 32. The connector of item 31, wherein the second housing component prevents movement of the optical subconnectors along a connector mating axis connector which is the x axis.
   Item 33. The connector of item 32, wherein the first housing component prevents movement of the optical subconnectors along the y and z axes.
   Item 34. The connector of any of items 31 through 33, wherein the second housing component allows for limited movement of the optical subconnectors along a connector mating axis which is the x axis.
   Item 35. The connector of item 34, wherein the second housing component allows for limited movement of the optical subconnectors along the y and z axes.
   Item 36. The connector of any of items 31 through 35, wherein:

the first housing component comprises a carrier configured to receive the optical subconnectors; and

the second housing component comprises a retaining clip that prevents the movement of the optical subconnectors along the x axis which is a mating axis of the optical connector, wherein the retaining clip configured to be inserted into and removed from the first housing component along the z axis.

Item 37. The connector of item 36, wherein the first housing component comprises an array of compartments, each compartment comprising a cavity configured to receive one of the optical subconnectors.
Item 38. The connector of item 37, wherein the array is a two column array.
Item 39. The connector of item 38, wherein the retaining clip comprises:

a first pin configured to engage first sides of optical subconnectors disposed in cavities of a first column of the two column array; and

a second pin configured to engage with first sides of optical subconnectors disposed in cavities of a second column of the two column array.

Item 40. The connector of any of items 31 through 39, wherein:

the first housing is a base housing; and

the second housing component comprises:
a carrier configured to fit within the base housing; and
a float coupling between the first housing component and the second housing component, wherein the float coupling provides for limited movement of the optical subconnectors along the x axis which is a mating axis of the connector.
   Item 41. The connector of item 40, wherein first housing component further comprises a slidable coupling that provides for limited movement of the optical subconnectors along the y and z axes.
   Item 42. The connector of item 41, wherein:

the slidable coupling is a pin and slot coupling; and

the base housing includes a slot configured to engage with a pin mounted to a substrate.

Item 43. An optical connector comprising:

a carrier;

multiple optical subconnectors disposed within the carrier, each optical subconnector comprising:
a subconnector housing; and
one or more optical cable assemblies, each optical cable assembly comprising at least one optical ferrule and at least one optical waveguide; and

a retaining clip configured to be inserted and removed from the carrier, the retaining clip preventing movement of one or more of the multiple optical subconnectors along a mating axis of the optical connector when the mating clip is disposed within the carrier.

Item 44. An optical connector comprising:

a base housing;

a carrier disposed within the base housing; and

multiple optical subconnectors disposed within the carrier, each optical subconnector comprising:
a subconnector housing; and
one or more optical cable assemblies, each optical cable assembly comprising at least one optical ferrule and at least one optical waveguide; and

a float coupling that allows limited translational movement of the carrier and the optical subconnectors along the mating axis of the optical connector.

Item 45. An optical connector assembly, comprising:
first and second optical connectors configured to be mated together, each optical connector comprising:
multiple optical subconnectors, each optical subconnector comprising:
   a subconnector housing; and
   one or more optical cable assemblies, each optical cable assembly comprising at least one optical ferrule and at least one optical waveguide;
a first housing component; and
a second housing component, wherein control of x, y, and z translation of the multiple optical subconnectors is distributed between the first and second housing components such that each housing component controls movement of all of the multiple optical subconnectors along at least one but not all of the x, y, and z axes.
   Item 46. The connector assembly of item 45, wherein:

the second housing component of the first optical connector prevents movement of the optical subassemblies of the first optical connector along a mating axis of the first and second optical connectors which is the x axis; and

the second housing component of the second optical connector provides limited movement of the optical subassemblies of the second optical connector along the mating axis.

Item 47. The connector assembly of any of items 45, wherein:

the first housing component of the first optical connector is configured to prevent movement of the optical subassemblies of the first optical connector along the y and z axes; and

the first housing component of the second optical connector provides limited movement of the optical subassemblies of the second optical connector along the y and z axes.

Item 48. The optical connector assembly of any of items 45 through 47, wherein:

the optical connector is configured to be mounted on a first substrate; and

the second optical connector is configured to be mounted on a second substrate, wherein when the first optical connector is mated to the second optical connector the first substrate is oriented substantially perpendicular to the second substrate.

Item 49. An optical connector comprising

a base housing;

a carrier disposed within the base housing;

multiple optical subconnectors retained within the carrier, each optical subconnector comprising:
a subconnector housing; and
one or more optical cable assemblies disposed within the subconnector housing, each optical cable assembly comprising at least one optical ferrule and at least one optical waveguide; and

a float coupling between the base housing and the carrier that allows simultaneous translational movement of the carrier and all of the multiple optical subconnectors along a mating axis of the optical connector.

Item 50. The optical connector of item 49, wherein the float coupling comprises one or more springs.
Item 51. The optical connector of item 49, wherein the float coupling comprises an elastomeric material.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Various modifications and alterations of the embodiments discussed above will be apparent to those skilled in the art, and it should be understood that this disclosure is not limited to the illustrative embodiments set forth herein. The reader should assume that features of one disclosed embodiment can also be applied to all other disclosed embodiments unless otherwise indicated. It should also be understood that all U.S. patents, patent applications, patent application publications, and other patent and non-patent documents referred to herein are incorporated by reference, to the extent they do not contradict the foregoing disclosure.

1. An optical subconnector comprising:
a subconnector housing;
one or more optical cable assemblies disposed within the subconnector housing, each optical cable assembly comprising at least one optical ferrule and at least one optical waveguide;
a shutter that covers mating ends of the optical ferrules; and
a shutter activation mechanism coupled to the shutter and configured to reversibly engage with a shutter activation mechanism of a mating optical subconnector such that during unmating of the optical subconnector and the mating optical subconnector, the shutter activation mechanism of the mating optical subconnector pulls the shutter activation mechanism of the optical subconnector along a mating axis of the optical subconnector causing the shutter to close.

2. The optical subconnector of claim 1, wherein the shutter activation mechanism is configured to engage with the shutter activation mechanism of the mating optical connector during mating such that during mating of the optical connector with the mating optical connector:
the shutter activation mechanism of the mating optical connector pushes the shutter activation mechanism of the mating optical connector along the mating axis causing the shutter to open; and
the shutter activation mechanism of the connector pushes the shutter activation mechanism of the mating optical connector open along the mating axis causing the shutter of the mating optical connector to open.

3. An optical connector comprising:
a housing;
one or more optical subconnectors disposed within the housing, each optical subconnector comprising:
a subconnector housing;
one or more optical cable assemblies disposed within the subconnector housing, each optical cable assembly comprising at least one optical ferrule and at least one optical waveguide;
a shutter that covers mating ends of the optical ferrules; and
a shutter activation mechanism coupled to the shutter and configured to reversibly engage with a shutter activation mechanism of a mating optical subconnector such that during unmating of the optical subconnector and the mating optical subconnector, the shutter activation mechanism of the mating optical subconnector pulls the shutter activation mechanism of the optical subconnector along a mating axis of the optical connector causing the shutter to close.

4. An optical connector comprising:
a carrier;
multiple optical subconnectors disposed within the carrier, each optical subconnector comprising:
a subconnector housing; and
one or more optical cable assemblies, each optical cable assembly comprising at least one optical ferrule and at least one waveguide; and
a movement control component separable from the multiple optical subconnectors and the carrier, the movement control component configured to control movement of the multiple optical subconnectors along a mating axis of the optical connector.

5-10. (canceled)

11. The optical subconnector of claim 1, wherein the shutter activation mechanism is configured to move relative to the subconnector housing during mating and unmating.

12. The optical subconnector of claim 1, wherein the shutter is a two piece shutter comprising a first half and a second half.

13. The optical subconnector of claim 12, wherein;
the first half of the shutter is rotatably attached to the shutter activation mechanism at a first side of the subconnector housing; and
the second half of the shutter is rotatably attached to the shutter activation mechanism at an opposing second side of the subconnector housing.

14. The optical subconnector of claim 13, wherein:
the first half of the shutter is configured to slide over the first side of the subconnector housing during mating; and
the second half of the shutter is configured to slide over the second side of the subconnector housing during mating.

15. The optical subconnector of claim 1, wherein the shutter is a clamshell shutter comprising:
a first half shell; and
a second half shell, each of the first and second half shells rotatably attached to the shutter activation mechanism, the first and second half shells configured to extend along the mating axis and meet at a vertex when the shutter is closed.

16. The optical subconnector of claim 1, wherein:
the subconnector housing is coupled to the shutter activation mechanism by a rail and channel coupling on multiple sides of the subconnector housing;
at least one of the rail and channel couplings includes a rail of the shutter activation mechanism that slides in a channel of the subconnector housing, wherein the rail of the shutter activation mechanism includes a slot and the channel of the subconnector housing includes a peg that fits inside the slot.

17. The optical connector of claim 3, wherein the housing comprises a carrier having one or more compartments, each compartment including a cavity configured to respectively accept one of the optical sub connectors.

18. The optical connector of claim 16, wherein each compartment includes a latch that secures a subconnector housing of the optical subconnectors in its respective cavity.

19. The optical connector of claim 16, further comprising a retaining clip that secures all the subconnector housings of the one or more optical subconnectors in their respective cavities.

20. The optical connector of claim 4, wherein the movement control component is a retaining clip that substantially prevents movement of all of the optical subconnectors along the mating axis.

21. The optical connector of claim 19 wherein the retaining clip is configured to be inserted into the carrier along an axis perpendicular to the mating axis.

22. The optical connector of claim 20, wherein the carrier includes multiple compartments, each compartment having a cavity configured to receive one of the multiple optical sub connectors.

23. The optical connector of claim 21, wherein:
the compartments are arranged in columns; and
the retaining clip one or more pins, each pin configured to secure a column of optical subconnectors within their respective cavities.

24. The optical connector of claim 4, wherein the movement control component simultaneously controls movement of all of the multiple optical subconnectors.

25. The optical connector of claim 4, further comprising a base housing, the carrier configured to fit at least partially within the base housing, wherein the movement control component comprises a float coupling that couples the carrier to the base housing, the float coupling allowing limited movement of the carrier and the multiple optical subconnectors along the mating axis.

26. The optical connector of claim 4, wherein the carrier comprises multiple compartments, each compartment having a cavity configured to receive one of the multiple optical subconnectors.
